(19) United States
(12) Patent Application Publication
(10) Pub. No.: US 2004/0198857 A1
(43) Pub. Date: Oct. 7, 2004

(54) Photochemical reactions using multi-photon upconverting fluorescent inorganic materials

(76) Inventors: Matthew J. Dejneka, Corning, NY (US); Michael E. DeRosa, Painted Post, NY (US); Stephen L. Logunov, Corning, NY (US)

Correspondence Address: CORNING INCORPORATED, SP-TI-3-1, CORNING, NY, 14831

(21) Appl. No.: 10/405,685

(22) Filed: Apr. 1, 2003

(51) Int. Cl. C08G 2/00; C08F 2/46; C08J 3/28

(52) U.S. Cl. 522/2; 522/66

(57) ABSTRACT

A pioneering process of inducing a photochemical reaction involves upconverted fluorescence from a rare earth ion doped inorganic glass, crystal or other inorganic material. An inorganic host material doped with a rare earth ion capable of upconversion fluorescence is provided. A photoactiveable organic material is positioned at a surface of the inorganic host material, and radiation is directed at the inorganic host material to cause multiple photons to be absorbed by the rare earth ion. A single photon is emitted from the rare earth ion and is absorbed by a chemical species in the photoactivateable organic material to induce a chemical reaction.

### BACKGROUND OF THE INVENTION

1. Field of the Invention

This invention relates to methods of inducing photochemical reactions using multi-photon upconverting fluorescence.

2. Technical Background

The mechanisms and methods of using ultraviolet (u.v.) and visible wavelengths to initiate photochemical reactions by single photon processes are well understood and are used to cure materials such as adhesives, inks, and coatings for numerous industrial applications. Recently, several research groups have demonstrated two-photon-initiated photoreactions of organic systems and their potential for application in areas such as optical data storage and three-dimensional microlithography. Examples of the use of two-photon initiated photoreactions of organic systems used for optical data storage are described for example, in U.S. Pat. No. 5,289,407 and U.S. Pat. No. 6,267,913. Fabrication of three-dimensional structures using multi-photon excitation (i.e., photolithography) is described, for example, in U.S. Pat. No. 6,316,153.

Reactions such as photopolymerization using a two-photon process is different from a conventional single-photon process in several important ways. During single-photon polymerization, a photoinitiator dissolved in a polymerizable monomer or oligomer, absorbs a single photon that is sufficient to raise the molecule to an excited state. In the excited state, photochemical processes occur that enable the photoinitiator to generate a free radical or other activated species (e.g., such as in the case of cationic photoinitiators). These activated species initiate chain polymerization reactions in the monomer which ultimately leads to high molecular weight polymer. For a single photon process, the rate of absorption of photons is directly proportional to the intensity (dw/dt is proportional to I).

Typically, photoinitiators are efficiently activated with light in the 240-370 nm range. However, photosensitizers and special dyes can be added to help initiate photopolymerization at longer wavelengths well into the visible (400-635 nm) range. Practical processes using single photon induced polymerization have not been reported at wavelengths longer than 600-650 nm. However, N. J. Turro, Modern Molecular Photochemistry, University Science Books, Sausalito, Calif., pages 609-611 (1991) has described a photochemical reaction that is hypothetically capable of producing blue light (400-450 nm) from near infrared light (2600 nm) by a process called uphill photosensitization.

During a two-photon process, a photoreactive molecule absorbs two photons of a longer wavelength nearly simultaneously via a virtual state. The virtual states exist for the duration of the excited light pulse. Typical two-photon absorption (TPA) cross sections in molecules are very low and require power densities as high as about 10 GW/cm² (gigawatts per square centimeter). Power densities of this magnitude are typically achieved by using highly focused ultra fast laser pulses (having a pulse duration in the range from picoseconds to femtoseconds) with high peak power. Power densities can be also achieved in the range of GW/cm² with CW radiation but the laser power must be extremely high. (The military is using such systems for weapons platforms.) In the case of continuous wave radiation the power densities are typically much too low to initiate TPA processes requiring a virtual energy state. The result of the TPA process is that two photons of longer wavelength can be used to excite molecules with sufficient TPA cross sections to a level that is typically achieved by a single photon of about half the wavelength of the photons used in the two-photon process. For a two-photon process, the rate of absorption of photons is proportional to the square of the intensity (dw/dt is proportional to I²)

The two-photon initiated polymerization (TPIP) process occurs by two primary mechanisms. In the first case, two-photons are absorbed by an initiator with a sufficient TPA cross section and the initiator directly generates a free radical subsequent to absorbing the two-photons. The second mechanism of TPIP is by two-photon fluorescence. If the molecular structure is correct, the two-photon excited energy level can relax to the ground state and emit a photon at a wavelength roughly half that of the pump photon. This fluoresced wavelength is then absorbed by a conventional single photoninitiator in the material and photopolymerization takes place via one-photon process.

The unique conditions needed to achieve TPIP allow photopolymerization in very small volumes. TPA can only occur where the intensity is high enough to generate photochemically active species. Typically this is achieved by focusing the laser to a very small focal volume within the material. Therefore, TPIP only takes place in this very small focal volume and polymerization does not occur outside the focal volume. Using this aspect of TPIP researchers have demonstrated three-dimensional photolithographic features having a size of less than one micron.

Much like two-photon fluorescence that can be generated within organic materials, inorganic crystals and glasses doped with rare earth ions such as thulium (Tm³⁺) can also be made to generate upconverted fluorescence by a multi-photon process. In fact, due to the unique electronic structure of the rare earth ions these types of materials can be made to generate upconverted fluorescence by two, three and even four photon processes. Because the excited energy levels in an ion such as thulium are real rather than virtual states, the excited states are relatively long-lived with typical lifetimes on the order of microseconds to tens of milliseconds. The power density required to achieve a reasonable amount of upconverted radiation is on the order of about 0.1 MW/cm² due to the high cross sections of the ground state absorption (GSA) and excited state absorptions (ESA). This allows photons of very long wavelengths (e.g., 980, 1120, 1430-1480 nm) to be upconverted using focused continuous wave (CW) sources rather than ultra fast pulsed sources.

### SUMMARY OF THE INVENTION

The invention provides a pioneering method of inducing photochemical reactions at selected area regions of an organic material using multi-photon upconverting fluorescent glass or crystal. The methods of the invention are capable of selectively inducing photochemical reactions in area elements having dimensions in the micron range without requiring high power and/or ultra fast pulsed wave radiation sources. Potential applications include photolithography, fabrication of three-dimensional structures having very fine (e.g., micro-sized) features, photocuring of coatings, curing of organic compositions for photonic and/or semiconductor devices, and surface photochemistry for biophotonics.

In accordance with an aspect of this invention, there is provided a process of inducing a photochemical reaction using a multi-photon upconverting fluorescent inorganic material. The process involves providing an inorganic host material doped with a rare earth ion capable of upconversion fluorescence (absorption of multiple pump photons and emission of shorter wavelength fluorescence). A photoactiveatable organic material is positioned at the surface of the inorganic host material. Thereafter, radiation is directed at the inorganic host material to cause multiple photons to be absorbed by the rare earth ion and emission of a desired fluorescence spectrum from the rare earth ion at a shorter wavelength than the incident radiation. The fluorescence photoactivates a photoactiveatable chemical species in the photoactivatable organic material to induce a chemical reaction.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the invention.

### BRIEF DESCRIPTION OF THE DRAWINGS

FIG. 1 is a schematic showing an experimental setup of a multi-photon upconversion photopolymerization process.

FIG. 2 is an absorption spectrum of an uncured adhesive composition and an emission spectrum of a Tm³⁺ doped glass pumped using an 1120 nm pump laser.

FIG. 3 is a micrograph showing four photopolymerized regions in the adhesive of FIG. 2 on the surface of a Tm³⁺ doped glass cured by multi-photon upconverted fluorescence using an 1120 nm pump laser.

FIG. 4 is a schematic diagram of an experimental setup used for demonstrating photopolymerization through a 0.5 millimeter thick silicon wafer using an 1120 nm pump laser and multi-photon upconversion fluorescence from a Tm³⁺ glass substrate.

FIG. 5 is an absorption spectrum of an uncured adhesive and silicon compared to a Tm³⁺ doped glass emission using an 1120 nm pump laser.

FIG. 6 is a micrograph showing a polymerized region of the adhesive composition of FIG. 5 on the surface of a Tm³⁺ doped glass.

FIG. 7 is a schematic illustration of the upconversion scheme for Tm³⁺ with 1120 and 1430-1480 nm pumps.

FIG. 8 is a schematic illustration of an experimental setup used to demonstrate upconversion photopolymerization on the surface of a Tm³⁺ doped glass using a continuous wave 1430 nm or 1480 nm Raman fiber laser.

FIG. 9 is an emission spectrum of a Tm³⁺ doped glass pumped with 1430 nm radiation.

FIG. 10 is a micrograph showing photopolymerized regions in an adhesive cured by multi-photon upconverted fluorescence on a surface of a Tm³⁺ doped glass using 1430 nm radiation (2 watts) for three minutes.

### DETAILED DESCRIPTION OF THE PREFERRED EMBODIMENTS

A pioneering process of inducing a photochemical reaction at an interface using a new range of very long wavelength continuous wave sources that are commercially available utilizes multi-photon upconverted fluorescence from rare earth ions distributed in an inorganic host material. The process of this invention may be used for selectively inducing a photochemical reaction, such as photopolymerization, photobleaching, photochromism, etc., within an organic material.

Two-photon excitation refers to the simultaneous absorption of two photons by a chromophore. Excited states that are normally accessed via single photon absorption may also be excited via absorption of two quanta each having half the energy of the single photon. In accordance with this invention, the rare earth ions of an inorganic material doped with the rare earth ions are utilized for two-photon excitation and/or multi-photon excitation. The two or more photons impinge on the rare earth ion to achieve an excited state. The photons energies have to be in resonance with transitions between levels of the rare earth ion. The excitation rate is proportional to the intensity of the incident radiation raised to the ninth power, where n is the number of photons involved in the excitation. In the case of two-photon absorption, the excitation rate has quadratic dependence of the intensity of the incident radiation. Excitation is thereby confined to the focal volume where the intensity is sufficiently high. Such excitation may be produced by a laser which provides sufficient incident intensities to produce simultaneous absorption of two or more photons by the rare earth ions contained in the doped inorganic host material.

The rare earth ion doped inorganic material is exposed to one or more focused pump wavelengths to generate multi-photon upconverted fluorescence with emitted wavelengths in the range of for example 290-820 nm when the doping ion is Tm³⁺. This can be a two, three, four or even five photon process depending on the pump wavelength used. Continuous wave pump wavelengths that can be used include, for example, wavelengths near 650, 980, 1120, 1140-1480 nm, and combinations of these wavelengths in the case of Tm³⁺. The upconverted photons that are emitted from the rare earth ions may be absorbed by a photoactivateable organic material positioned at a surface of the inorganic host material doped with the rare earth ion. For example, the photoactiveable organic material may comprise a photopolymerizable composition containing reactive monomers and/or oligomers, a photoinitiator, and an optional photosensitizer. After absorption of the upconverted photons occurs, photopolymerization is initiated by a single-photon process. The rate of reaction can be optimized for a particular application. Such optimization may include selection of appropriate rare earth ion dopant or dopants, selection of inorganic host material, selection and concentration of photoinitiator and optional photosensitizer, selection of an appropriate pump power and wavelength, etc. The process of this invention may be used to spot cure regions (e.g., approximately 100 to 200 microns) close to the fluorescing glass substrate or to cure larger regions (greater than about one centimeter) depending on how efficiently the emitted upconvented wavelengths are scattered into and throughout the photopolymerizable material. In principle, very small features (approximately 10 μm or smaller) can be generated by this technique similar to those obtained with TPIP using two-photon fluorescing dyes but can be achieved with ten thousand times less pump intensity. The resolution will depend on the power density (power of the source and focusing optics), wavelength of the pump, and glass composition.

The inorganic host material must be transparent to both the incident photon directed at the rare earth ions and to the upconverted photon emitted from the rare earth ions. Suitable transparent inorganic host materials include various glasses, glass-ceramics, and crystalline materials. The host glass or crystal is preferably water free. Halides and chalcogenide glasses are preferred over oxide based glasses because they have been found to offer better upconverting efficiencies. Heavy metal oxides (such as tellurites, germanates and gallates) are preferred over silicates due to their higher upconverting efficiencies. Thus, metal oxide glasses comprised primarily of a heavy metal oxide or combination of heavy metal oxides selected from tellurium oxide, gallium oxide and germanium oxide are preferred over silicon oxide glasses. A glass comprised primarily of these heavy metal oxides is one in which the equivalent weight of the heavy metal oxides exceeds the equivalent weight of silicon dioxide. A heavy metal oxide is a metal oxide comprised of a metal having an atomic weight greater than that of silicon.

Rare earth ions are ions of the rare earth elements. The rare earth elements include lanthanum, cerium, praseodymium, neodymium, promethium, samarium, europium, gadolinium, terbium, dysprosium, holmium, erbium, thulium, ytterbium and lutetium. Examples of suitable rare earth ions that may be employed as dopants include Tm³⁺, Pr³⁺, Nd³⁺, Dy³⁺, Ho³⁺, Er³⁺, Yb³⁺, and combinations of these ions.

The processes of this invention may be used for performing various photochemical reactions including photosynthesis, photodecomposition, photoreduction, photoxidation, photocatalytic reaction, photosterilization, photocleaning, photoheating, photodeoderization, photoisomerization and the like. Specific and preferred photochemical reactions that may be performed using the processes of this invention include photopolymerization, photobleaching and photochromism.

In the case of photopolymerization, the photoactivateable organic material used in the processes of this invention is a composition including polymerizable material. Such photopolymerizable compositions ordinarily contain a photoinitiator, one or more monomers, and/or one or more oligomers and/or polymers and/or cross-linkers, which are capable of free radical or cationic chain propagation. The initiator may or may not be covalently attached to a cross-linker, monomer, oligomer and/or polymer. Suitable photoinitiators for radical polymerization include, but are not limited to azo compounds such as azobisisobutyronitrile, peroxides such as benzoyl peroxide, aliphatic carbonyl compounds such as ketones and diketones, and aromatic diketones such as benzophenone and its derivatives. Other photoinitiation systems include but are not limited to redox-type photoinitiators useful in aqueous systems (e.g., ion pairs such as Fe³⁺OH⁻, and Pb²⁺Cl⁻), photosensitive dyes such as eosin, rose Bengal, and erythrosin, and transition metal derivatives such as Mn₂ (CO)₁₀ in the presence of organic halides.

Suitable free radical polymerization compounds include, but are not limited to cross-linkers, monomers, oligomers and/or polymers having at least one olefinic (unsaturated) bond, such as cross-linkers, monomers, oligomers and/or polymers which form polyalkylenes and halogenated polyalkylenes, polyacrylates, polymethacrylates, polyacrylamides, polyvinyl aromatics such as polystyrene, etc.

Photoinitiators for cationic polymerization include but are not limited to triarylsulfonium and diaryliodonium salts with complex metal halide anions, and mixed arene cyclopentadienyl metal salts of complex metal halide anions. Suitable cationic polymerizable compounds include but are not limited to epoxides such as cyclohexene oxide.

The photoactivateable organic materials used in this invention may be photopolymerizable precursor compositions in which each propagation step is effected by the incident radiation, and photopolymerization may be achieved using photo-cross-linking agents such as bisarylazides or photo-cross-linkable oligomers and polymers. Such oliogomers and polymers contain chromophoric groups that undergo light-induced chemical bonding with each other. The chromophoric groups may be in the polymer backbone, for example, a backbone chalcone group, or pendant, for example a poly(vinylcinnamate).

Generally, any precursor composition that is photoactiveable and which is substantially transparent to the radiation outside the focal point is within the scope of the present invention. Such photoactivateable materials include, but are not limited to, the above-described and other organic monomers (including dyes and chiral species), oligomers, polymers, etc.

The photoactiveable organic material, and in particular photopolymerizable compositions, may further contain a photosensitizer which absorbs the upconverted emitted light from the rare earth ions and transfers energy to the photoinitiator, so as to induce additional decompositions of the photoinitiators with subsequent free radical formation. Examples of photosensitizers include thioxanthen-9-one, 2-isopropylthioxanthen-9-one and 10-phenylphenoxazine.

With the processes of this invention, photopolymerization is initiated by upconverted fluorescence from a rare earth ion doped inorganic glass, crystal or other inorganic host material. The mechanism of fluorescence generation is fundamentally different from conventional all organic two-photon polymerization systems. The rare earth ions are excited via real energy levels as opposed to organic two-photoninitiators that are excited through virtual states. As a result, the processes of this invention are more efficient. A further advantage is that the processes of this invention may be executed with relatively inexpensive light sources.

The processes of this invention allow photopolymerization to be initiated using three and four-proton upconverted fluorescence. Researchers have recently demonstrated three-photon upconverted fluorescence in an all organic material (See ref. G. S. He; P. P. Markowicz; T-C. Lin; P. N. Prasad, “Observation of stimulated emission by direct three photon excitation”, Nature, Vol. 6873, pp. 767-770, 2002). Though this group demonstrated three-photon upconversion in an all organic material they did not demonstrate photopolymerization. They also still had to use a 150 femtosecond pulsed laser at 1.3 micron pump wavelength.

Our invention is still very different from this technology. We can say that three photon upconversion in all organic materials is very rare. To our knowledge more than three-photon upconversion fluorescence has not been demonstrated in all organic systems. The probability of inducing three and four-proton processes in an organic system is very low. As a practical matter, the power density required for three or more photon events in organic systems would likely damage the material. This is not the case for upconversion utilizing rare earth doped inorganic hosts.

The invention allows utilization of continuous wave radiation sources for upconverted photopolymerization, and for two or three-photon upconverting organic systems. This is possible because rare earth ions have very high cross-sections for GSA and ESA. They also have long lifetimes at the intermediate electronic levels. The power densities required for efficient upconversion fluorescence in accordance with this invention is much less than the power densities typically required in all organic systems. In particular, the processes of this invention may be achieved by directing radiation at the inorganic host material having a power density less than 1 GW/cm², preferably less than 100 MW/cm², and even more preferably less than 10, and even less than 1 MW/cm². In fact, the power densities required for efficient upconversion fluorescence in accordance with this invention are on the order of about 0.1 MW/cm². This is about five orders of magnitude lower than the power density required for typical two-photon excited fluorescence in the known organic systems.

With the processes of this invention, photopolymerization can be induced using the longest continuous wave pump wavelengths ever reported (e.g., 980 nm, 1120 nm, 1430-1480 nm) or combination the sources. Typical single photon photosensitized materials can be polymerized only at wavelengths that are generally less than about 650 nm. Two-photon processes typically use Ti:Sapphire sources which use 800 nm radiation.

With an appropriate pump wavelength or wavelengths and power selection, cured features may be as small as those made using conventional TPIP (less than 10 μm). The combination of a few different wavelength pumps with appropriate power density selection at the desired spot could provide improved efficiency curing. With very long pump wavelengths it is possible to photocure materials that are usually opaque to curing wavelengths less than 800 nm. For example, it is possible to photocure through materials like silicon which would be impossible with other methods of photocuring.

The processes of this invention may utilize a pump laser source that is much less expensive and easier to use than the Ti:Sapphire sources typically used with conventional two-photon photopolymerization processes. For example, the processes of this invention may utilize a fiber laser pump source having a cost that is approximately one-fifth of the cost of a Ti:Sapphire source.

Multiple radiation sources generating different wavelengths which are in resonance with certain transitions of the rare earth ion may be used. In such case, it is possible to optimize power densities of the multiple (more than one) radiation sources to achieve optimum fluorescence yield.

The step of positioning a photoactiveable organic material at a surface of the inorganic host material may be achieved by coating, depositing or otherwise locating the photoactivateable organic material on or adjacent the inorganic host material doped with a rare earth ion. As another alternative, the inorganic host material doped with a rare earth ion may be dispersed in the form of particles throughout a matrix comprising the photoactiveable organic material.

The invention will now be described with respect to specific non-limiting examples.

Proof of Principal

1) Photopolymerization Using an 1120 nm Fiber Laser Pump Source

Photopolymerization was demonstrated by multi-photon upconverted fluorescence on the surface of a Thulium ion doped (Tm³⁺) inorganic glass. Exemplary glasses used were 827 OP and 827 OS whose compositions are listed in Tables I and II.

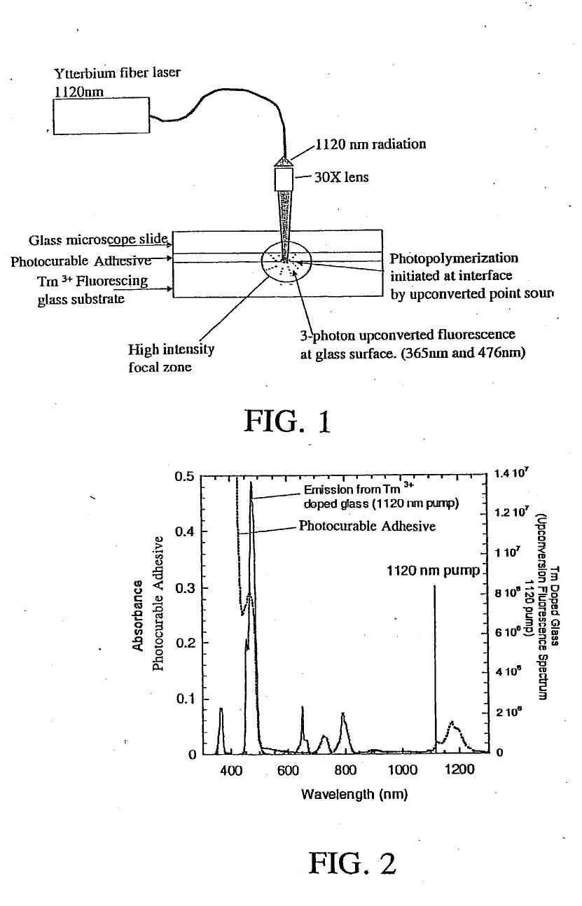

The test setup for the demonstration is shown in FIG. 1. A photopolymerizable composition was placed at the interface between the Tm³⁺ doped glass and a borosilicate microscope slide. A CW 1120 nm Ytterbium fiber laser (IRE Polus Model YLD-10K-1120) was used as the pump source. The radiation emitting from the pump fiber laser was focused through a 32× objective lens onto the surface of the Tm³⁺ doped glass. At the focus in the glass substrate, multiphoton upconversion occurred and blue photons were emitted, which could be easily seen by eye. (See upconversion fluorescence spectrum in FIG. 2). The blue photons were absorbed by the photopolymerizable composition and initiated photopolymerization. Four spots in the polypolymerizable composition were exposed to 400 mW of 1120 nm radiation for 2 minutes at each spot. The selected photopolymerization composition can only be cured by 365 nm light. This indicates that there was sufficient 365 nm radiation present to photocure this system.

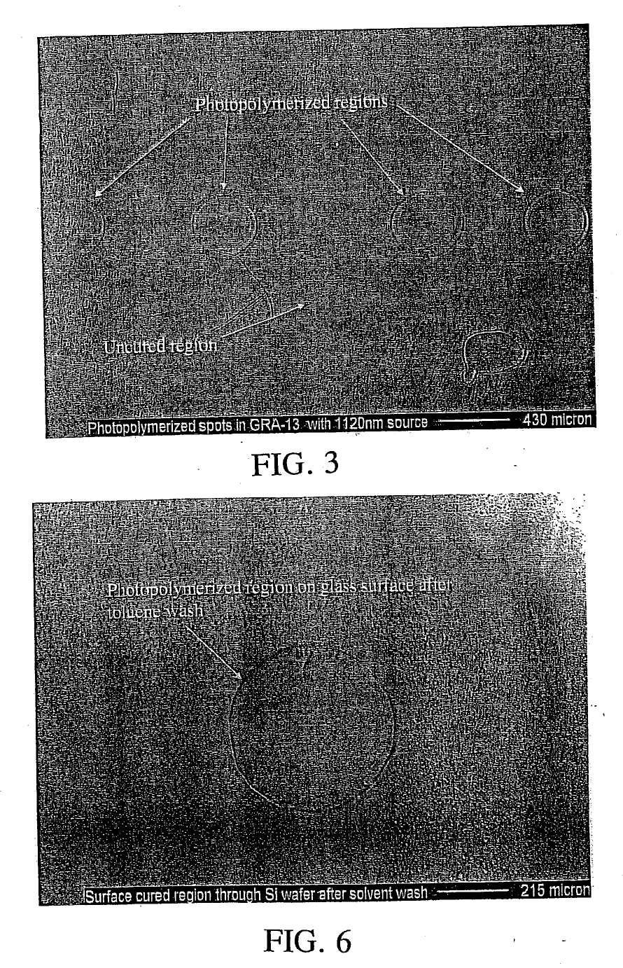

After exposure the selectively cured photocurable compositions were examined under the microscope. FIG. 3 shows the photopolymerized regions. To determine if the spots were polymerized we removed the top glass slide and washed the unreacted photopolymerized compositions away with toluene. The solidified (polymerized or cured) structures remained adhered to the Tm³⁺ doped glass.

A control experiment proved that the upconverted fluorescence and not the 1120 nm pump laser was responsible for the polymerization reaction. Using the same test apparatus as shown in FIG. 1, three spots with the 1120 nm pump were focused into the Tm³⁺ glass so that blue light was generated. After the third spot was written, the focus of the beam was repositioned by using the Z-stage micrometer to place the focus of the 1120 source above the surface of the Tm³⁺ glass directly at the photopolymerized composition. In this position, no blue light was generated. Three more regions were exposed under the same power and exposure time as the spots that had blue light. Polymerized regions were only observed where blue light was present. There was no polymerized regions where only 1120 nm was present.

TABLE I

| | 827 OP |
|---|---|
| | Grams |
| BATCH MATERIALS | |
| GERMANIUM DIOXIDE | 47.1 |
| GALLIUM OXIDE | 16.9 |
| BARIUM CHLORIDE DIHYDRATE | 4.20 |
| CALCIUM CARBONATE | 3.87 |
| CALCIUM FLUORIDE | 1.01 |
| POTASSIUM NITRATE | 3.48 |
| RUBIDIUM CARBONATE | 3.96 |
| THULIUM OXIDE | 0.62 |
| COMPOSITION (WGT %) | |
| GEO2 | 61.4 |
| GA203 | 22.0 |
| BAO | 3.44 |
| CL | 1.59 |
| CAO | 3.77 |
| F | 0.638 |
| K20 | 2.11 |
| RB20 | 4.17 |
| TM203 | 0.810 |
| COMPOSITION (MOL %) | |
| GEO2 | 70.0 |
| GA203 | 14.0 |
| BAO | 2.67 |
| CAO | 6.00 |
| CaF₂ | 2.00 |
| K20 | 2.67 |
| RB20 | 2.66 |
| TM203 | 0.250 |

TABLE II

| | 827 OS |
|---|---|
| | Grams |
| BATCH MATERIALS | |
| GERMANIUM DIOXIDE | 63.3 |
| GALLIUM OXIDE | 19.4 |
| BARIUM NITRATE | 2.27 |
| BARIUM CHLORIDE DIHYDRATE | 4.22 |
| CALCIUM FLUORIDE | 1.35 |
| CALCIUM CARBONATE | 6.05 |
| POTASSIUM NITRATE | 5.25 |
| RUBIDIUM CARBONATE | 6.00 |
| THULIUM OXIDE | 1.67 |
| COMPOSITION (WGT %) | |
| GEO2 | 62.1 |
| GA203 | 19.1 |
| BAO | 3.90 |
| CL | 1.20 |
| CAO | 4.28 |
| F | 0.644 |
| K20 | 2.40 |
| RB20 | 4.76 |
| TM203 | 1.64 |
| COMPOSITION (MOL %) | |
| GEO2 | 70 |
| GA203 | 12 |
| BAO | 1 |
| BaCl₂ | 2 |
| CaF₂ | 2 |
| CaO | 7 |
| K20 | 3 |
| RB20 | 3 |
| TM203 | 0.5 |

2) Photopolymerization Through Silicon Using An 1120 nm Fiber Laser Pump Source

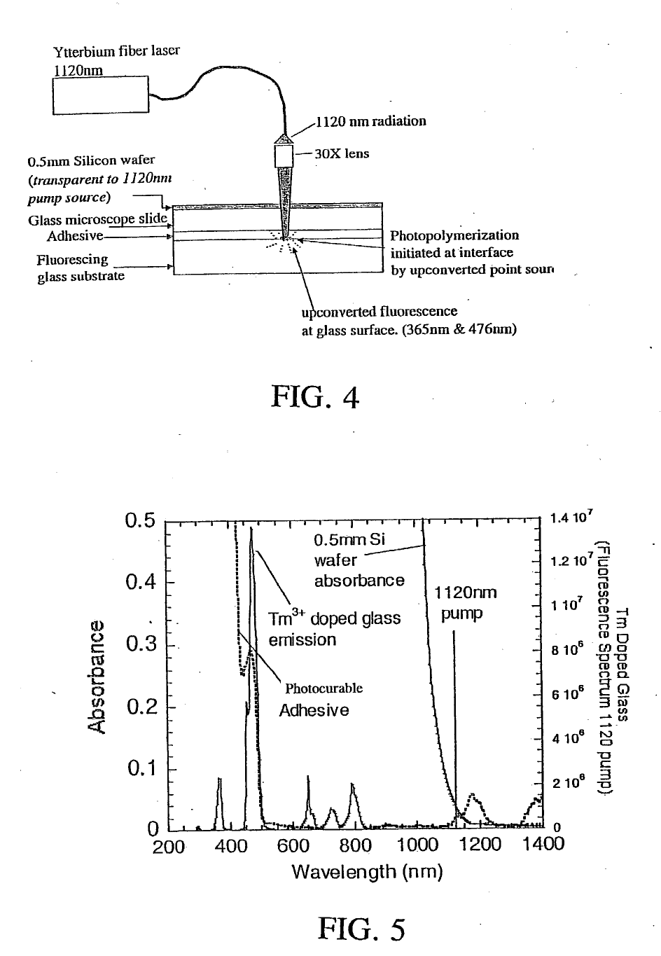

It was demonstrated that polymerization could be achieved through a 0.5 mm thick silicon wafer by using an 1120 nm pump laser which is in the transparent region of silicon. The test setup is shown in FIG. 4. The 1120 nm pump laser was focused through the silicon, top glass slide, and the photopolymerizable material onto the surface of the Tm³⁺ doped glass. Three regions were exposed to 700 mW for 3 minutes to produce three photocured regions. The unreacted adhesive was washed away with toluene to reveal photopolymerized adhesive adhered to the surface of the Tm³⁺ glass. FIG. 5 shows the absorption spectra of silicon, photocurable adhesive, and the upconversion emission of the Tm³⁺ doped glass. FIG. 6 shows a micrograph of the photopolymerized regions.

3) Photopolymerization Using A 1430 nm or 1480 nm Fiber Laser Pump Source

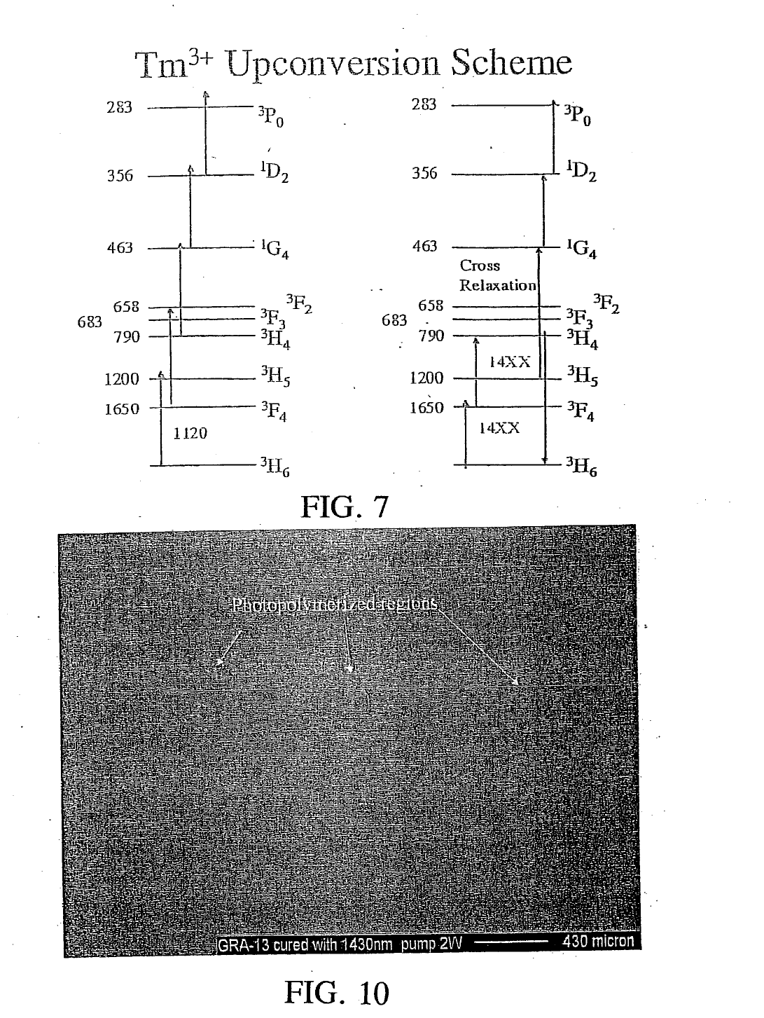

Due to the unique electronic structure of Tm³⁺, upconverted fluorescence was induced by using even longer pump wavelengths than 1120 nm. By absorbing three 1120 nm photons, the Tm³⁺¹G₄ level is populated, giving rise to 467 nm blue fluorescence as shown in FIG. 7. When a fourth pump photon is absorbed by a Tm³⁺ ion in the ¹G₄ excited state, it gets further excited to the ¹D₂ level which is responsible for the 365 and 445 nm fluorescence. The ¹G₄→¹D₂ ESA is not highly resonant with the 1120 nm pump so the ¹D₂ emission at 365 nm is not as strong relative to the ¹G₄ at 467 nm as it is for the 14XX nm pump scheme (also shown in FIG. 7), since the ¹G₄→¹D₂ ESA is highly resonant with the 14XX nm pump. Thus for optimal UV production at 365 nm it is beneficial to have at least one pump wavelength in the 14XX nm band. This is evident in FIG. 9 which shows the enhanced UV emission at 365 nm relative to the blue 467 nm emission. This is opposite to the unconversion spectrum in FIG. 5 which shows 5×more blue relative to UV emission.

The fluorescence generated by this upconversion was efficient and capable of generating enough fluorescence intensity at 365 nm, 445 nm and 460 nm to induce photopolymerization. Tm³⁺ is not the only ion, that can be used for upconversion. Many other rare earth ions could be used as well.

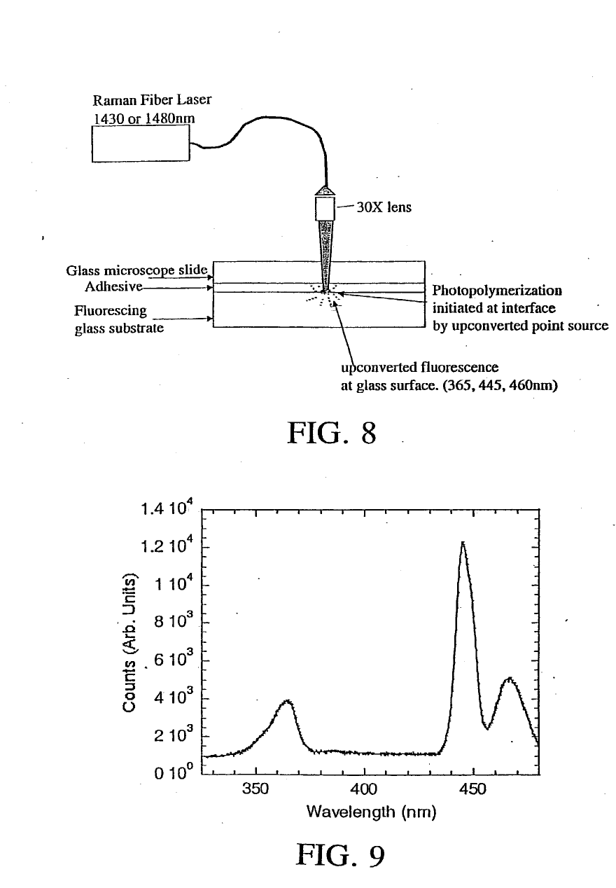

FIG. 8 shows the test schematic of the setup used to demonstrate photopolymerization at 1430 nm and 1480 nm. Spots were polymerized on the surface of Tm³⁺ doped glass using photocurable adhesive. Using a 1430 nm CW Raman fiber laser source (IRE Polus), three spots were photopolymerized using a 2 W exposure for 3 minutes at each spot. Using a 1480 nm CW Raman fiber laser source, photocured regions were produced using 1 W for only 2-3 minute exposure. Photocuring exposure pump power and exposure time were not optimized. It is most probable that photopolymerization could be initiated by using less power and time.

FIG. 9 shows the upconversion emission spectrum of Tm³+ glass pumped by 1430 nm. FIG. 10 shows the photocured regions cured by 1430 nm pumped upconversion.

It will become apparent to those skilled in the art that various modifications to the preferred embodiment of the invention as described herein can be made without departing from the spirit or scope of the invention as defined by the appended claims.

The invention claimed is:

1. A process of inducing a photochemical reaction, comprising:
providing an inorganic host material doped with a rare earth ion capable of multiple photon absorption and emission of a desired fluorescence spectrum;
positioning a photoactivateable organic material at a surface of the inorganic host material; and
directing radiation at the inorganic host material to cause multiple photons to be absorbed by the rare earth ion and the desired fluorescence spectrum to be emitted from the rare earth ion, the fluorescence photoactivating a photoactivateable chemical species in the photoactivateable organic material to induce a chemical reaction.

2. The process of claim 1, wherein the inorganic host material is a glass.

3. The process of claim 2, wherein the glass material is comprised primarily of heavy metal oxides.

4. The process of claim 3, wherein the glass material is comprised primarily of a heavy metal oxide or a combination of heavy metal oxides selected from tellurium oxide, gallium oxide, germanium oxide and combinations of these heavy metal oxides.

5. The process of claim 1, wherein the inorganic host material is a crystalline material.

6. The process of claim 1, wherein the inorganic host material is a chalcogenide glass.

7. The process of claim 1, wherein the inorganic host material is a halide glass.

8. The process of claim 1, wherein the rare earth ion is selected from Tm³⁺, Pr³⁺, Nd³⁺, Dy³⁺, Ho³⁺, Er³⁺, Yb³⁺ and combinations of these ions.

9. The process of claim 1, wherein the photoactivateable organic material is a composition including photopolymerizable material.

10. The process of claim 9, wherein the photopolymerizable material is selected from monomers, oligomers, polymers, and combinations of these photopolymerizable materials.

11. The process of claim 9, wherein the photopolymerizable material contains a photosensitizer.

12. The process of claim 1, wherein the inorganic host material is dispersed in particulate form in the photoactivateable organic material.

13. The process of claim 1, wherein the radiation directed at the inorganic host material is provided by a fiber laser pump source.

14. The process of claim 1, wherein the power density of the radiation directed at the inorganic host material is less than 1 gigawatt per square centimeter.

15. The process of claim 1, wherein the power density of the radiation directed at the inorganic host material is less than 100 megawatts per square centimeter.

16. The process of claim 1, wherein the power density of the radiation directed at the inorganic host material is less than 10 megawatts per square centimeter.

17. The process of claim 1, wherein the power density of the radiation directed at the inorganic host material is less than 1 megawatt per square centimeter.

18. The process of claim 1, wherein the radiation directed at the inorganic host material is a focused continuous wave.

19. The process of claim 1, wherein the radiation directed at the inorganic host material has a wavelength of at least 980 nm.

20. The process of claim 1, wherein multiple sources emitting radiation at different wavelengths are used for directing radiation at the inorganic host material.

21. The process of claim 20, wherein the different radiation wavelengths are in resonance with transitions of the rare earth ion.

22. A process of inducing photopolymerization, comprising:
providing an inorganic host material doped with a rare earth ion capable of multiple photon absorption and emission of a desired fluorescence spectrum;
positioning a photopolymerizable organic material at a surface of the inorganic host material; and
directing radiation at the inorganic host material to cause multiple photons to be absorbed by the rare earth ion and the desired fluorescence spectrum to be emitted from the rare earth ion, the fluorescence photoactivating a photoinitiator in the photopolymerizable organic material to induce photopolymerization.
